(19) United States
(12) Patent Application Publication
(10) Pub. No.: US 2008/0287163 A1
(43) Pub. Date: Nov. 20, 2008

(54) Method and apparatus for converting between a multi-sector, omni-base station configuration and a multi-sector base station configuration

(75) Inventors: Ulf Skarby, Lidingo (SE); Rune Johansson, Upplands Vasby (SE); Sven Patrik Lindell, Sollentuna (SE); Dan Anders Lindqvist, Sollentuna (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (Publ),, Stockholm (SE)

(21) Appl. No.: 11/798,921

(22) Filed: May 17, 2007

(51) Int. Cl. H04M 1/00

(52) U.S. Cl. 455/562.1

(57) ABSTRACT

A base station includes multiple sector antenna units. Each sector antenna unit has an antenna for receiving a carrier signal associated with an antenna frequency in an available frequency band. The base station is converted between a multiple sector base station configuration and a multi-sector, omni-base station configuration. In a diversity base station implementation, each sector antenna unit receives a diversity signal from a first sector, and the second diversity antenna unit receives a diversity signal from a second different sector. If one sector antenna unit does not perform properly so that one of the sector diversity signals is lost or corrupted, the other sector diversity signal is still useable. The base station may be reconfigured to power-down at least some part of the transmit side without having to power-down some or all of the receive side.

### RELATED APPLICATION

This application relates to commonly-assigned, U.S. patent application Ser. No. 11/607,082, filed Dec. 1, 2006.

### TECHNICAL FIELD

The technical field relates to omni-base stations that include multiple sector antennas and multi-sector base stations.

### BACKGROUND

An omni-base station is a base station that is configured to use an omni-antenna, and a sector base station is configured to use multiple (two or more) sector antennas. FIG. 1A shows a single cell area for a base station (BS) with an omni-antenna. An omni-antenna radiates 360 degrees to provide coverage over the entire cell area. FIG. 1B shows single cell area for a base station (BS) with three sector antennas. A three sector base station is a common sector configuration, but more or less sectors could be used. In this case, the cell area is divided into thirds, with each sector antenna having a narrower beam (as compared to an omni-antenna) that radiates to provide coverage over its sector area of approximately 120 degrees.

A base station antenna is often mounted in an elevated location, such as on a tower, a pole, on the top or sides of buildings, etc., to enhance coverage and provide better possibilities for direct radio signal propagation paths. FIG. 2A shows a base station unit 14 located at the base of a tower 12. An antenna 10 is mounted on the top of the tower 12 and is connected via a feeder cable 16, typically a coaxial cable or the like, to the base station transceiver. The received signal suffers signal losses traversing the feeder 16, and the taller the tower 12, the longer the feeder, and the greater the loss. In order to offset such signal losses in the feeder, a tower-mounted amplifier (TMA) may be used to amplify the received signal before it is sent over the feeder to the base station unit. FIG. 2B shows a TMA 18 mounted at the top of the tower 12 near antenna 10. A tower mounted unit is sometimes called a mast head amplifier. The term tower mounted amplifier (TMA) is used generically herein to include any device that performs this pre-feeder amplification function.

FIG. 3 shows a simplified block diagram of an omni-base station 20. The antenna 10 is connected to a duplex filter 21 in the TMA 18 which includes a receive (Rx) filter 22 and a transmit (Tx) filter 24. The duplex filter makes it possible to send and receive on the same antenna by separating the Tx and Rx signals from each other. The transmit filter 24 is connected directly to the feeder 16, and the receive filter 22 is connected to the feeder 16 via a low noise amplifier (LNA) 26. The feeder 16 couples to the base station 14 which also includes a duplex filter 28 having a receive filter (Rx) 30 and a transmit (Tx) filter 32. The transmit filter 32 is connected to a radio unit/transceiver 36 that includes a receiver 37 and a transmitter 38, and the receive filter 30 is connected to the radio unit 36 via a low noise amplifier 34.

Antenna diversity may be used in order to improve reception (or transmission) of transmitted radio signals. There are many kinds of diversity, such as time diversity, space diversity, polarization diversity, and combinations thereof. Space diversity reduces the effects of fading received radio signals. An antenna diversity systems comprises at least two antennas arranged at a distance from each other. In the case of receive diversity, the received signal is received on the two or more antennas. The receive Rx signals from the diversity antennas are subjected to diversity processing in order to obtain an enhanced signal. Diversity processing may, for example, include selecting the antenna signal which is strongest, or adding the signals and further processing the resulting signal. In transmitter diversity, the transmit TX signal is transmitted on the two or more transmit antennas to which the transmitter is connected. Antennas of a diversity arrangement are called diversity antennas. In diversity arrangements, a feeder and its associated antenna may be referred to as a diversity branch or simply a branch.

FIG. 4 shows an example of an omni-base station 14 with diversity. Two diversity antennas 10a and 10b are connected to corresponding TMAs 18a and 18b. Each TMA is connected by a corresponding feeder 16a and 16b to a corresponding duplex filter and low noise amplifier unit 42a and 42b in the base station 14. The two duplex filter and LNA units 42a and 42b are connected to a single radio unit 36.

In contrast to the single transceiver used in the omni-base station, a sector base station such as that shown at 50 in FIG. 5 has a separate transceiver for each sector. Three sectors are supported with each sector having its own antenna 10₁, 10₂, and 10₃. Each of the antennas 10₁, 10₂, and 10₃ is connected to a corresponding sector TMA 18₁, 18₂, and 18₃. Three feeders 16₁, 16₂, and 16₃ couple respective TMAs 18₁, 18₂, and 18₃ to corresponding base station units 14₁, 14₂, and 14₃. Each of the base station units 14₁, 14₂, and 14₃ has a corresponding duplex filter and low noise amplifier unit 42₁, 42₂, and 42₃. A sector base station provides more coverage than an omni-base station but at higher monetary and power costs.

Although omni-base stations are less complex and less expensive than sector base stations, they also provide less coverage, and therefore, an operator must install more omni-base stations to cover a particular geographic area than if sector base stations were installed. In response, multi-sector omni-base stations were introduced where an omni-base station is connected to a multi-sector antenna system. In fact, in an example where a three sector antenna system is used with an omni-base station, the three sector antenna system adds approximately 7-8 dB of signal gain. Another benefit of a multi-sector omni-base station is the ability to “tilt”, e.g., downtilt, one or more of the sector antennas. Tilting is not an option for omni antennas.

An example of a three sector base station 60 is shown in FIG. 6A. Three sectors are supported with each sector having its own antenna 10₁, 10₂, and 10₃. Each of the antennas 10₁, 10₂, and 10₃ is connected to a corresponding sector TMA 18₁, 18₂, and 18₃. Three feeders 16₁, 16₂, and 16₃ couple respective TMAs 18₁, 18₂, and 18₃ to the base station 14. The base station 14 includes three duplex filter and low noise amplifier units labeled generally at 42 connected to three radio units/transceivers 36. But because feeder cables, duplex filters, and transceivers are expensive, (even more so when diversity is used in each sector), a splitter/combiner 44 is used so that only one feeder is necessary. FIG. 6B shows how the received signals from the three sectors 1, 2, and 3 are combined together in a splitter/combiner 44 onto one feeder cable 16. In the transmit direction, the transmit signal is split into three identical signals (at lower power) and provided to each sector's TMA. If the carriers are not moved in frequency before combining, the receiver suffers a 5 dB degradation.

Network operators must have sufficient capacity to satisfy high demands during time periods of peak traffic volume even though there are often also periods when the traffic volume is low. Moreover, operators often want to be able to readily add new capacity without significant time delays and cost. A more expensive multi-sector base station could be employed to provide the a greater capacity, but that full capacity is usually only necessary during peak periods. During off-peak times, some of the capacity is not used. Even though the capacity may not be used, that does not mean that the unused capacity is without cost. In fact, the power consumption (idle current) of a multi-sector base station during low traffic periods (e.g., all night long) is energy inefficient. And when more capacity is needed, the operator is faced with the reconfiguration costs (which are in addition to the equipment costs) in the form of labor costs like climbing the base station antenna tower to reconfigure the TMAs. It would be desirable to provide a multi-sector base station arrangement that can provide the needed capacity but also be more energy efficient and less costly.

Another problem in multi-sector base stations that employ diversity reception is that the diversity antenna outputs are all processed in the same TMA. That arrangement is fine unless one of the TMA units becomes faulty or disabled. In that case, the communication in that sector is completely lost. It would be desirable to improve the reliability of communication in multi-sector base stations that employ antenna diversity without having to add a redundant backup system.

### SUMMARY

A radio base station site includes multiple sector antenna units. Each sector antenna unit has an antenna for receiving a carrier signal associated with an antenna frequency in an available frequency band. (The term “frequency band” includes a single frequency as well as a range of frequencies.) A controller is configured to automatically convert the radio base station between a multi-sector base station configuration, where each sector antenna unit has an associated filtering unit and an associated radio unit, and a multi-sector omni-base station configuration, where at least two of the sector antenna units share in the base station a common filtering unit and a common radio unit. The conversion in either direction may be triggered by an operator input, a time of day, detected load conditions, predicted capacity demands, etc.

For the multi-sector omni-base station configuration, a frequency converter in the antenna unit converts the carrier signal received by one of the multiple antenna units from the antenna frequency to a different respective frequency. A narrowband filter filters out a part of the available frequency band of interest. More than one frequency converter may be employed. A combiner combines carrier signals associated with the multiple antenna units to create a composite signal for communication to the base station unit. At least two of the carrier signals associated with the multiple antenna units and combined in the combiner are provided on a feeder and received by receiving circuitry in the base station unit at a different frequency. The common radio unit includes frequency conversion circuitry for extracting individual ones of the sector diversity signals. Switching circuitry may be used to connect one or more of the sector signals to the feeder so that multiple sector signals are connected to the base station via the feeder and to connect the feeder signal to the radio units. Preferably, one or more of the associated filtering units and/or radio units is powered-down in this configuration to save energy. Depending on the implementation for the multi-sector omni-base station configuration, the number of multiple sector antenna units having a corresponding frequency converter may be less than the number of multiple sector antenna units or the same. The combiner may combine carrier signals associated with each of the multiple antenna units to create a composite signal in which all of the carrier signals combined are associated with a different frequency band or in which only some of the carrier signals to be combined are at a different frequency.

To obtain greater capacity, the multi-sector base station configuration may be used. In that configuration, a signal associated with each of the multiple units is provided (e.g., switchably) on a respective one of multiple feeders connected to the main base station unit. The signal routed from each of the multiple sector antenna units over a respective one of the multiple feeders is provided (e.g., switchably) for processing in a respective one of multiple radio units in the main base station unit.

Another advantageous aspect relates to diversity implementations in base stations having more than one sector. Each sector antenna unit may be connected to a first diversity antenna and a second diversity antenna, and wherein for the multi-sector omni-base station configuration, signals associated with each sector's first diversity antenna may be combined to create a first composite signal and to provide a first composite signal onto a first feeder connected to the base station unit. Signals associated with each sector's second diversity antennas may be combined to create a second composite signal and to provide a second composite signal onto a second feeder connected to the base station unit. To achieve enhanced base station reliability, each sector antenna unit may be connected to a first diversity antenna signal from one sector and to a second diversity antenna signal from a different sector. The base station unit includes a local oscillator associated with each sector, and while in the multi-sector omni-base station configuration, a same one of the local oscillators is preferably used to extract from the composite signal diversity signals from the same sector.

Yet another advantageous aspect relates to a reconfigurable multi-sector base station that permits selective power-down of the transmitter circuitry. The base station includes multiple sector antenna units, each of the multiple sector antenna units having an antenna for receiving a carrier signal associated with an antenna frequency in an available frequency band, and multiple base station transceivers, each transceiver having transmission circuitry and receiving circuitry, with each sector antenna unit being connectable to one of the multiple base station transceivers. Because the most power-consuming circuitry is in the transmitter side of the base station, the inventors devised a scheme for selectively powering down the transmitter side for a desired time interval without having to power down the receiver side. That way signals can still be received, but considerable power can be saved. Accordingly, a controller selectively powers down the transmission circuitry for a desired time interval to conserve power without having to power down the receiving circuitry. Using a transmission splitter, the controller can selectively switch between a first power saving mode, where the transmission splitter is activated to route a transmission signal to a transmission filter each one of two or more of the sectors, and a second higher power mode, where the transmission splitter is deactivated and a transmission signal is coupled to each sector transmission filter from its respective base station transmitter.

### BRIEF DESCRIPTION OF THE DRAWINGS

FIG. 1A shows single cell area for a base station (BS) with an omni-antenna;

FIG. 1B shows single cell area for a base station (BS) with three sector antennas;

FIG. 2A shows a base station tower;

FIG. 2B shows a base station tower with tower-mounted amplifier (TMA) and a switch/combiner unit;

FIG. 3 shows a simplified block diagram of an omni-base station;

FIG. 4 shows an example of an omni-base station with diversity;

FIG. 5 shows an example of a sector base station;

FIG. 6A shows an example of a three sector base station;

FIG. 6B shows an example of a three sector omni-base station using a splitter/combiner and one feeder cable;

FIG. 7 is a function block diagram of an example of a multi-sector, omni-base station with reduced combiner loss;

FIG. 8A is a diagram of an available frequency band divided into subbands at the antennas for, e.g., an 850 MHz band;

FIG. 8B is a diagram showing an example where different sector signals are frequency-translated to a corresponding subband in the available frequency band on the feeder;

FIG. 9A is a diagram of a PCS frequency band divided into 5 MHz subbands;

FIG. 9B is a diagram of showing an example where three different sector signals are frequency translated to a corresponding subband in the PCS frequency band on the feeder;

FIG. 10 is a flowchart outlining non-limiting example procedures for converting a base station between a multi-sector, omni-base station configuration and a multi-sector base station configuration;

FIGS. 11A and 11B are function block diagrams of non-limiting example embodiments of a base station that can be converted between a multi-sector, omni-base station configuration and a multi-sector base station configuration;

FIG. 12 is a function block diagram of another non-limiting example embodiment of a base station that can be converted between a multi-sector, omni-base station configuration and a multi-sector base station configuration;

FIGS. 13A and 13B are a function block diagram of another non-limiting example embodiment of a base station with diversity reception that can be converted between a multi-sector, omni-base station configuration and a multi-sector base station configuration; and

FIG. 14 is a function block diagram of yet another non-limiting example embodiment of a base station that can be converted between a multi-sector, omni-base station configuration and a multi-sector base station configuration;

FIG. 15 is a function block diagram of yet another non-limiting example embodiment of a base station with diversity reception that can be converted between a multi-sector, omni-base station configuration and a multi-sector base station configuration; and

FIG. 16 is a function block diagram of a non-limiting example embodiment of a reconfigurable multi-sector base station that permits selective power-down of the transmitter circuitry.

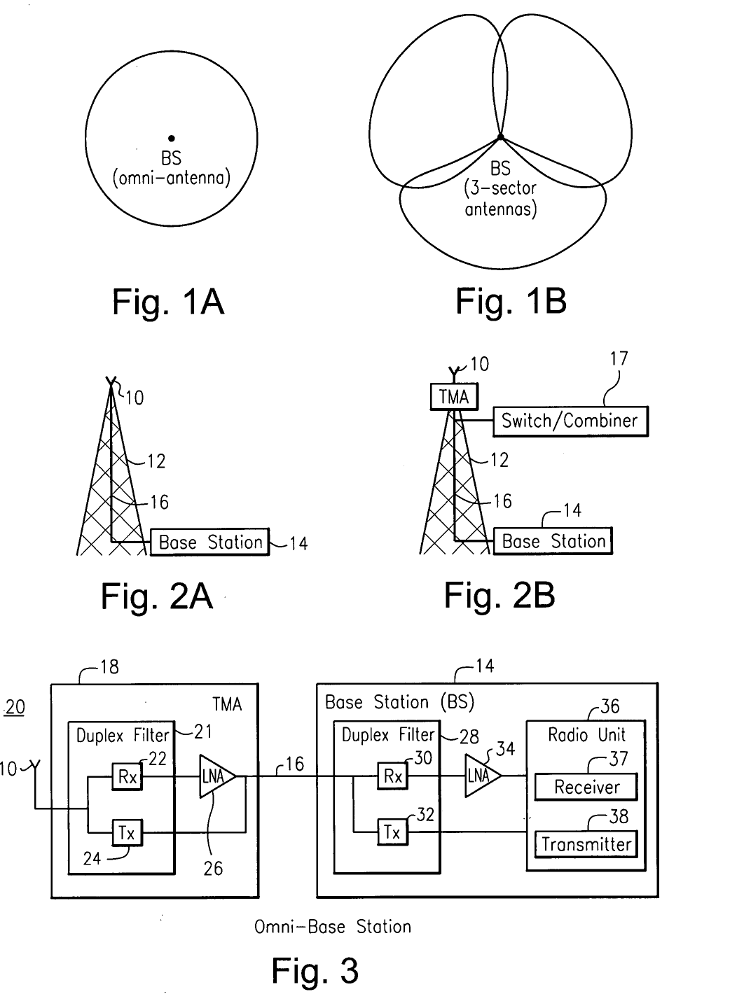

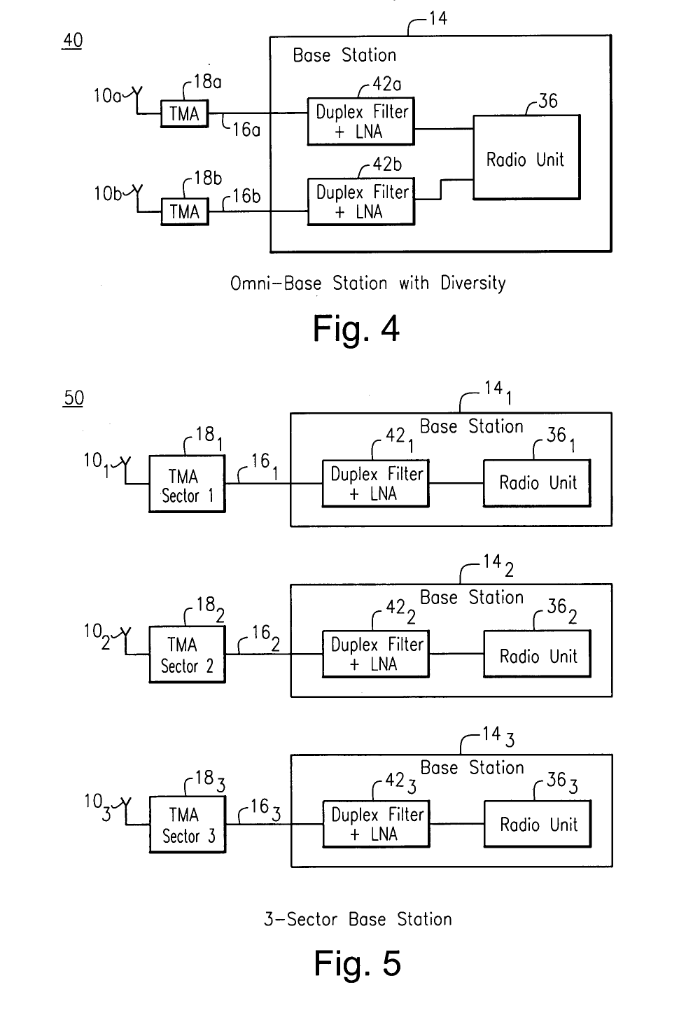

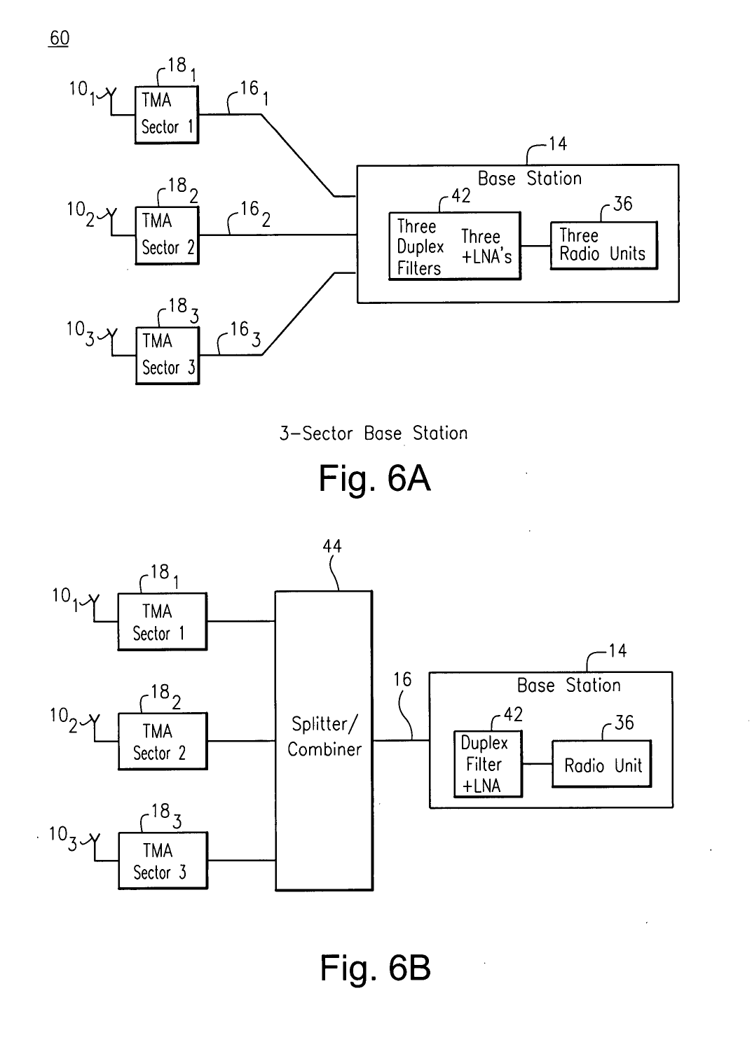

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. For example, while example embodiments are described in the context of multi-sector omni-radio base stations and multi-sector base stations, the disclosed technology may also be applied to other types of multi-antenna devices and to indoor as well as outdoor applications. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs).

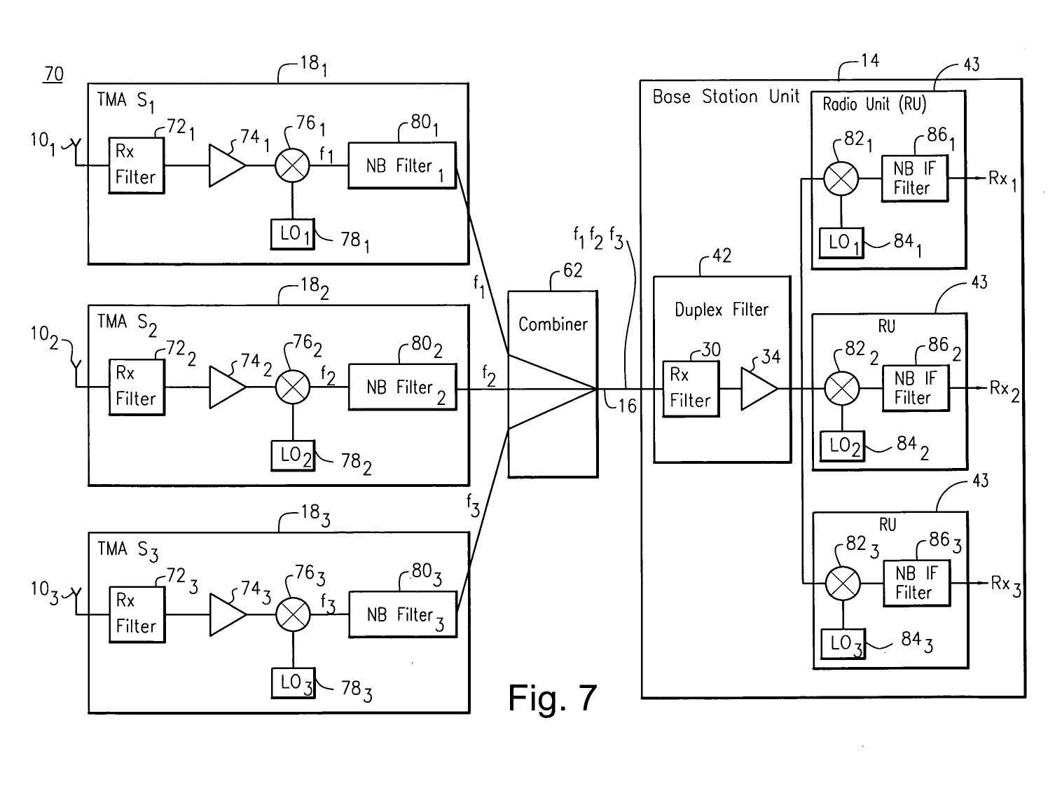

Before describing converting between a multi-sector, omni-base station configuration and a multi-sector base station configuration, a preferred but still example embodiment of a multi-sector, omni-base station 70 with reduced combiner loss is now described in conjunction with FIG. 7. Although the term “multiple” is understood to mean two or more, in this non-limiting example, three sectors S₁, S₂, and S₃ are supported, with each sector having its own antenna 10₁, 10₂, and 10₃. Other multiple sector implementations may be used, e.g., six sectors, etc. Each of the antennas 10₁, 10₂, and 10₃ is connected to a corresponding sector antenna unit referred to in a non-limiting way as a tower mounted amplifier (TMA) 18₁, 18₂, and 18₃. The three TMAs 18₁, 18₂, and 18₃ are connected to a splitter/combiner 62 so that only one feeder 16 is needed to couple the TMA received signals to an omni-base station 14 which includes a single duplex filter and low noise amplifier unit 42 which includes a receive filter 30 and a low noise amplifier 34. For simplicity, the transmit path has been omitted. Each TMA includes a receive (Rx) filter 72₁, 72₂, and 72₃ connected to its respective antenna 10₁, 10₂, and 10₃. For simplicity, the transmit paths are omitted in the figures and the description.

Each receive filter 72₁, 72₂, and 72₃ is connected to a respective amplifier 74₁, 74₂, and 74₃, and the amplified output is connected to a corresponding mixer 76₁, 76₂, and 76₃ where it is mixed with a frequency translating signal generated for example by a local oscillator 78₁, 78₂, and 78₃. In one non-limiting example, the frequency translating signal is different for each sector so that each sector signal is converted to a different frequency. Each mixer's output is filtered using a respective narrowband (NB) or bandpass filter 80₁, 80₂, and 80₃ centered on the respective frequency to remove other mixer products as well as noise and interference from other parts of the available band.

Although each sector signal is shown as frequency translated for the benefit of description only, one or more of the sector signals may not be frequency converted. Preferably, each sector signal is at a different frequency before being combined and transported to the omni-radio base station transceiver unit. In this three sector example, two of the sector signals could be frequency translated to different frequencies while the third sector signal is not frequency translated. In that case, the three sector signals are still at a different frequencies. The different frequencies are identified as f₁, f₂, and f₃. In a less optimal example implementation, some of the sector signals are at different frequencies but two or more sector signals remain at the same frequency. This implementation is less optimal because the signals at the same frequency interfere and the signal-to-noise ratio is reduced in the combiner.

Although not necessary, it may be desirable to frequency convert the combined signal to a different frequency, e.g., lower frequency, before transmitting the combined signal over the feeder 16. For example, converting the combined signal to a much lower frequency can minimize loss in the feeder 16 and thus further reduce noise.

At the base station unit 14, the feeder 16 connects to a duplex filter unit (FU) 42 of which only the receive filter 30 and LNA 34 are shown. The duplex filter unit 42 is connected to an omni-base station radio unit 43, only part of which is shown and includes mixers 82₁, 82₂, and 82₃. Normally, the multi-sector, omni-base station receiver would use one mixer at this stage followed by a narrowband filter to downconvert the received radio signal. But because each of the sector receive signals in this example is at a different frequency, three radio units (RUs) 43 including three different local oscillator signals LO₁, LO₂, and LO₃ are mixed with the composite signal from the combiner 62. Local oscillators 84₁, 84₂, and 84₃ provide those three different local oscillator signals LO₁, LO₂, and LO₃. In addition to other radio receiving circuitry, each radio unit also includes radio transmitting circuitry including a power amplifier. The additional radio unit circuitry is not illustrated in order to simplify the figures. Each output is then filtered in a narrowband intermediate frequency (IF) filter 86₁, 86₂, and 86₃ in its respective RU 43 to produce a corresponding sector receive signal Rx₁, Rx₂, and Rx₃. These sector receive signals Rx₁, Rx₂, and Rx₃ are then ready for further processing.

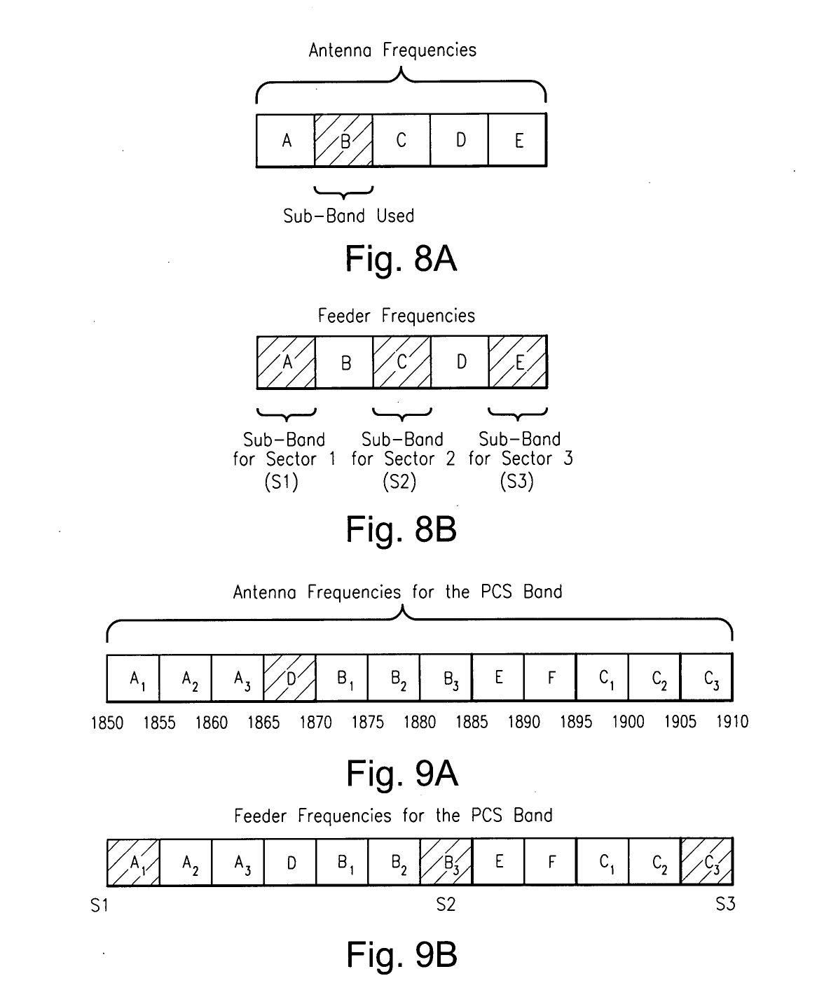

To help explain the frequency translation, an example is now described in conjunction with FIGS. 8A and 8B. FIG. 8A is a diagram of an available antenna frequency band divided into subbands A-E. However, subband B is the frequency band used by the omni-radio base station. FIG. 8B is a diagram showing an example where the three different sector signals all received in the used subband B are frequency translated to a corresponding subband in the available frequency band for the feeder: subbands A, C, and E are used. Although one of the sector signals need not be frequency translated and could remain in the used subband B, in this case, it is not desirable because there would be no guardband. Having a guard band reduces the chance of interference between the sector carrier signals.

A real world example in the Personal Communication Services (PCS) band is now described in conjunction with FIGS. 9A and 9B. FIG. 9A is a diagram of antenna frequencies for the PCS frequency band from 1850-1910 MHz divided into twelve 5 MHz subbands A₁, A₂, A₃, D, B₁, B₂, B₃, E, F, C₁, C₂, and C₃. The used subband by the radio base station is the 5 MHz D band from 1865-1870 MHz. For the three sector example, the three different sector signals all received in the used subband D are frequency translated to a corresponding feeder subband frequency in the available frequency band, which in this example are A₁, B₃, and C₃ as shown in FIG. 9B. However, one of the sector signals need not be frequency translated and could remain in the used subband D and there would still be a guard band separating the three sector signals.

In this non-limiting example, the receive filters 72₁, 72₂, and 72₃ each pass the available 60 MHz frequency band from 1850-1910 MHz. But the base station is only using the 5 MHz “D” subband from 1865-1870 MHz. The first sector received signal is frequency shifted to the A₁ subband, and a NB filter₁ passes frequencies between 1850-1865 MHz. The second sector received signal is frequency shifted to the B₃ subband, and a NB filter₂ passes frequencies between 1870-1885 MHz. The third sector received signal is frequency shifted to the C₃ subband, and a NB filter₃ passes frequencies between 1895-1910 MHz.

The frequency multiplexed signal carrying the three sector carriers at three different frequency bands A₁ (1850-1855), B₃ (1880-1885), C₃ (1905-1910) over the feeder 16 is processed by the omni-base station receiving circuitry. The received signal is filtered using the receive filter 30 which passes the 60 MHz wide PCS band from 1850-1910 MHz. After amplifying the filtered signal in the LNA 34, the amplified received signal is sent to three mixers 82₁, 82₂, and 82₃, one in this example for each sector where the sector signal was frequency converted before sending it over the feeder 16. The purpose of the receiving circuitry shown is to convert each sector signal to the same intermediate frequency (IF) signal. IF downconversion simplifies filtering and facilitates later baseband processing. To accomplish conversion to an IF of 200 MHz, the LO₁ is set to 1652.5 MHz; the LO₂ is set to 1682.5 MHz; and LO₃ is set to 1707.5 MHz. In this non-limiting example, the 200 MHz output from mixer 82, is then filtered by each of the three 5 MHz NB filter 86₁, 86₂, and 86₃ to pass frequencies from 197.5-202.5 MHz (centered around the 200 MHz IF).

Frequency converting the signals received on at least one or more sector antenna units used with an omni-radio base station permits combiner loss normally encountered when sector signals are combined without frequency conversion. If all the signals in a three sector omni-radio base station combined are at different frequencies, then approximately a 5 dB power loss is avoided in the combiner. That way fewer feeder cables can be used without incurring a substantial loss in the combiner. Indeed, only a single feeder cable need be used in non-diversity as well as in diversity implementations. More efficient multi-sector omni-base stations are commercially attractive because coverage and/or capacity for omni-base stations can be increased using sector antennas. Indeed, existing omni-base stations can be easily upgraded to full coverage base stations using sector receive antennas and frequency conversion before combining and transmission to the base station transceiver over a feeder cable. Another advantage is that the power consumption is lower because less hardware is used, e.g., especially fewer power amplifiers which consume more power than other radio components.

As explained in the background, network operators must have sufficient capacity to satisfy high demands during time periods of peak traffic volume even though there are often also periods when the traffic volume is low. A multi-sector omni-base station may not provide enough capacity during those peak periods. Operators also often want to able to readily add new capacity without significant time delays and cost. A more expensive multi-sector base station could be employed to provide the a greater capacity, but that full capacity is usually only necessary during peak periods. During off-peak times, some of the capacity is not used. The power consumption (e.g., current consumed by idling power amplifiers) of a multi-sector base station during low traffic periods (e.g., all night long) is energy inefficient. And when more capacity is needed, the operator is faced with the reconfiguration costs (which are in addition to the equipment costs) in the form of labor costs like climbing the base station antenna tower to reconfigure the TMAs. A solution to these problems is a reconfigurable base station that can be automatically switched from a multi-sector, omni-base station configuration and a multi-sector base station configuration and vice versa.

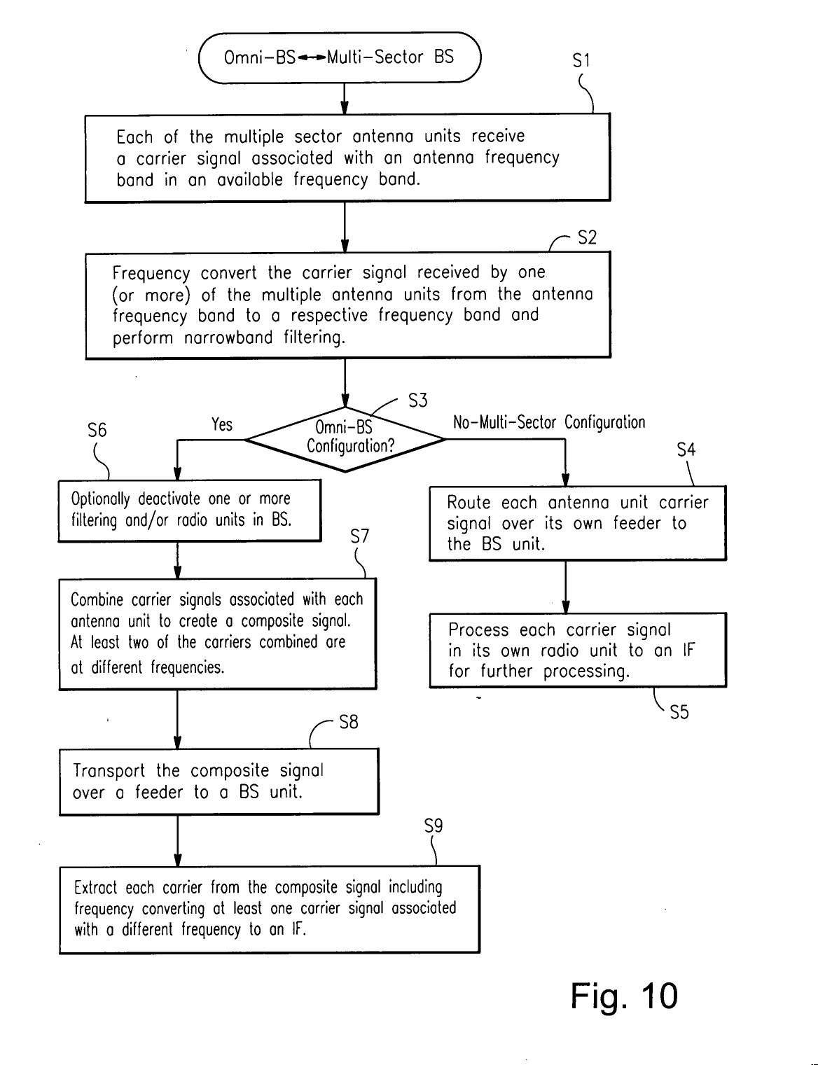

FIG. 10 is a flowchart outlining non-limiting example procedures for automatically switching a reconfigurable base station with multiple antenna sectors between a multi-sector, omni-base station configuration and a multi-sector base station configuration. In step S1, each of the multiple sector antenna units receives a carrier signal associated with an antenna frequency in an available frequency band. The carrier signal received by one of the multiple antenna units is frequency converted from the antenna frequency to a respective frequency different from the antenna frequency band and narrowband filtering (step S2). A decision is made whether a multi-sector omni-base station (BS) configuration is desired (step S3). The conversion in either direction may be triggered by an operator input, a time of day, detected load conditions, predicted capacity demands, etc., and be orchestrated by an electronic controller. If a multi-sector omni-base station (BS) configuration is not selected, e.g., higher capacity is required to accommodate a peak time period, a multi-sector configuration is desired, and each antenna unit carrier signal is routed over its own feeder to a base station radio unit (step S4). Each carrier signal is processed in its own radio unit and converted to an intermediate frequency (IF) for further processing.

But if for example during an off-peak time when less capacity is needed, then a more efficient, multi-sector, omni-base station configuration can be established. Although various multi-sector omni-base station configurations are shown in this case, other multi-sector omni-base station configurations could be used. Because one or more of the filter units and/or radio units need not be used in this configuration, they can be deactivated (powered-down) if desired to save power (step S6). Deactivating a radio unit including the transmitter power amplifier saves considerable power. At least two of the carrier signals associated with the multiple antenna units 42 and combined in the combiner to form a composite signal are at a different frequency (step S7). The composite signal is transported over a feeder to a base station unit (step S8). Each carrier signal is extracted from the composite signal including frequency converting at least one carrier signal associated with a different frequency to an intermediate frequency for further processing (step S9).

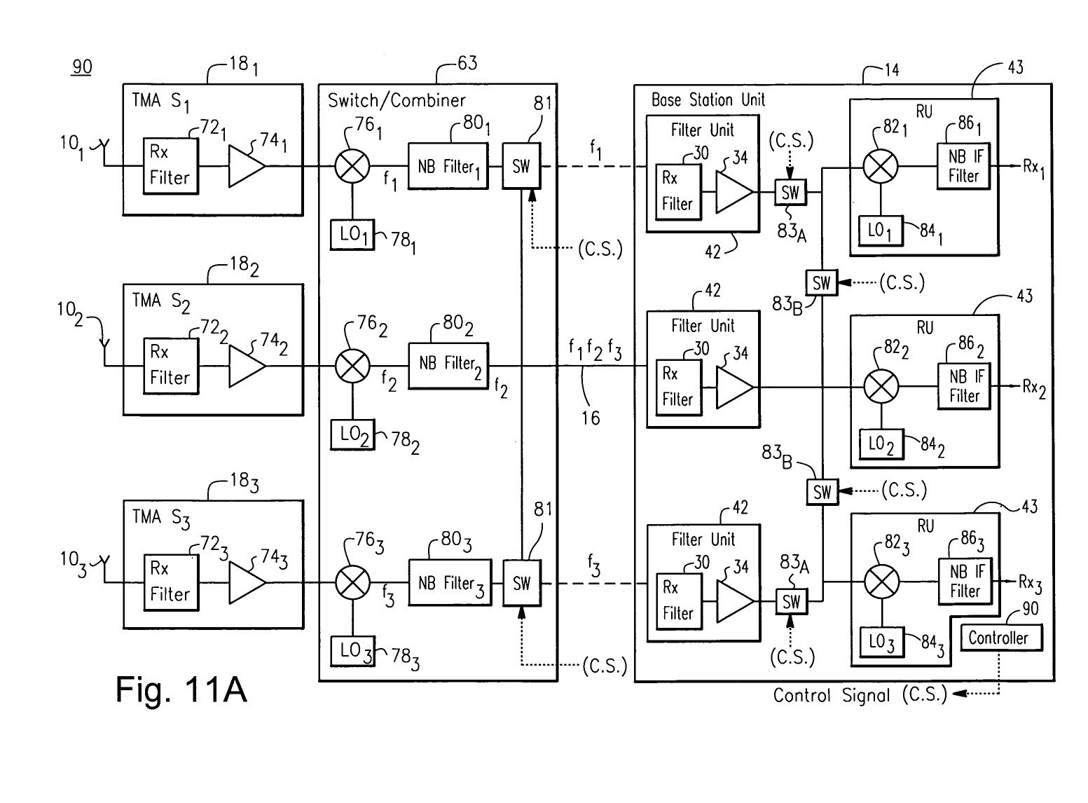

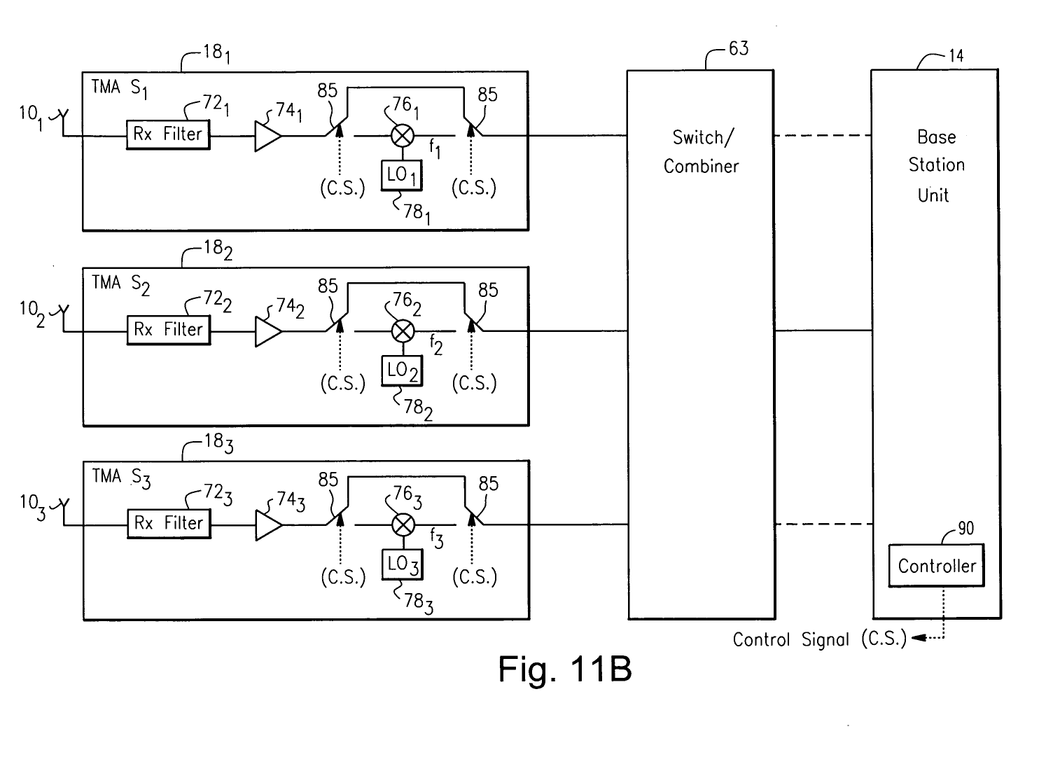

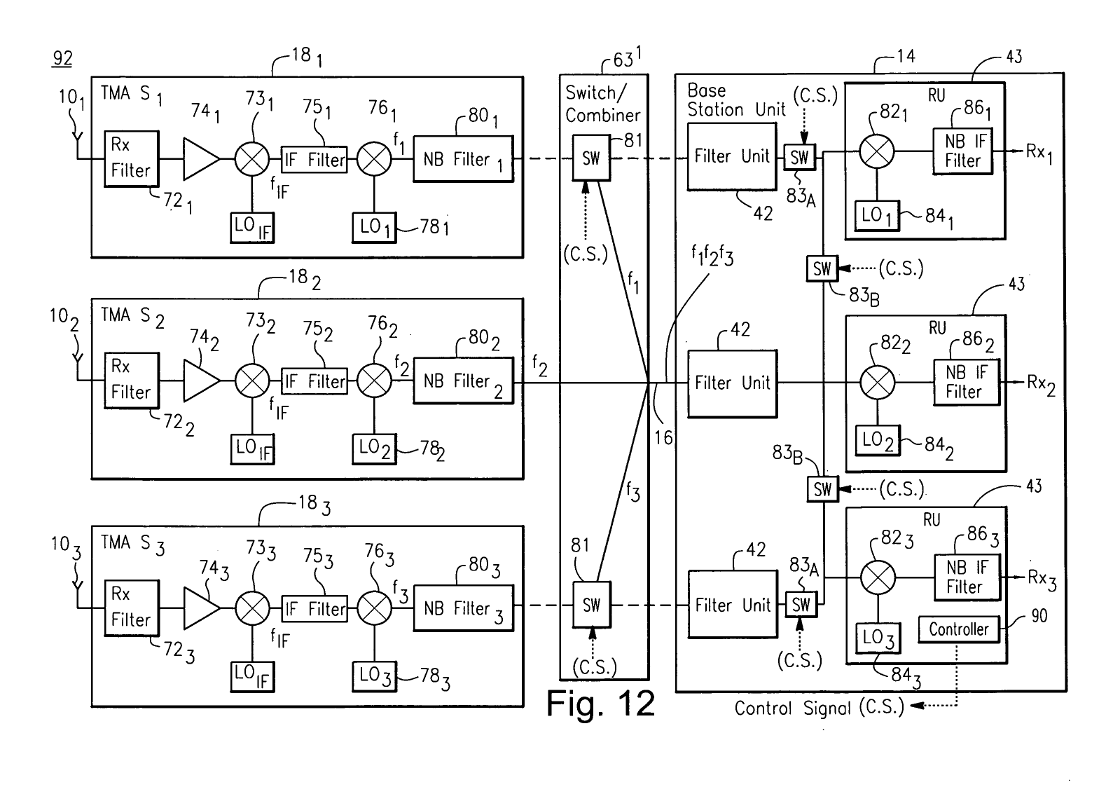

FIG. 11A is a function block diagram of another non-limiting example embodiment of a reconfigurable base station 90 that has multiple sectors. Although this example is similar in some respects to the base station shown in FIG. 7, here the frequency conversion for the multi-sector, omni-base station configuration is performed in a switch/combiner 63 instead of in the antenna units 18. The three antennas could be connected to one TMA unit that includes three receive filters, three LNAs, three frequency converters, three narrowband filters, and one switch/combiner connected to one feeder.

Also included in FIG. 11A are two switches 81, one of which is connected to the output of the NB filter 80₁ and the other of which is connected to the output of the NB filter 80₃. These switches 81 are controlled by switch control signals (C.S.) from a controller 90, which in this example is located in the base station unit 14, but could also be located in any suitable location from which the control signals could be generated and communicated to operate the switches. The base station unit also includes another set of switches 83_{A} and 83_{B} controlled by the controller 90. Switches 83_{A} and 83_{B} ensure that the filtered signal(s) is(are) provided to the appropriate mixer 82 in one or all three radio units 43. In a first switch position corresponding to a multi-sector omni-base station configuration, the switches 81 couple the three NB filter 80 outputs to the single feeder 16. The composite signal on that feeder is provided to the middle filter unit 42. In this configuration, the top and bottom radio units may be powered-down to save power. The switches 83_{A} are opened, and the switches 83_{B} are closed so that the output of that filter unit is provided to each of the three radio units (RUs) 43 which operate on the filtered composite signal as described in conjunction with FIG. 7. When the controller 90 sets the switches 81 in a second switch position corresponding to a higher capacity multi-sector base station configuration, the switches 81 couple the filter outputs to their own respective feeder 16 so three feeders (rather than one) are used. The signal on each feeder is provided to its own filter unit 42. The controller 90 closes switches 83_{A} and opens switches 83_{B} so that each filter unit's output is processed in its respective radio receiving unit (RU) 43.

In the above example, the sector signals are frequency-shifted in the switch/combiner 63 irrespective of the base station configuration. FIG. 11B shows another example embodiment where additional switches 85 are provided in each TMA 18 so that when the controller 90 sets these switches 85 in the switch position corresponding to a multi-sector base station configuration, the frequency converting operations in the TMA are bypassed. These frequency conversion operations are unnecessary in this configuration and can be avoided if desired. Similar bypass switching may be employed, if desired, in any base station configuration converting implementation when switched to a multi-sector base station configuration. But to simplify the following drawings, the bypass switching option in the sector antenna units is omitted.

FIG. 12 is a function block diagram of another non-limiting example embodiment of a reconfigurable base station 92 that has multiple sectors. Although similar in some respects to the reconfigurable base station shown in FIG. 11A, the frequency conversion includes an intermediate frequency (IF) conversion. Some reasons why an IF conversion might be employed first before performing the frequency conversion to separate the sector signals in frequency before combining include: (a) IF-filters are more effective than RF-filters, (b) IF down-conversion and up-conversion are better known techniques than RF-RF conversions, and (c) the feeder frequencies may be located where desired in the available frequency band. The mixers and the local oscillators in the base station down-convert the different frequencies to IF for further processing.

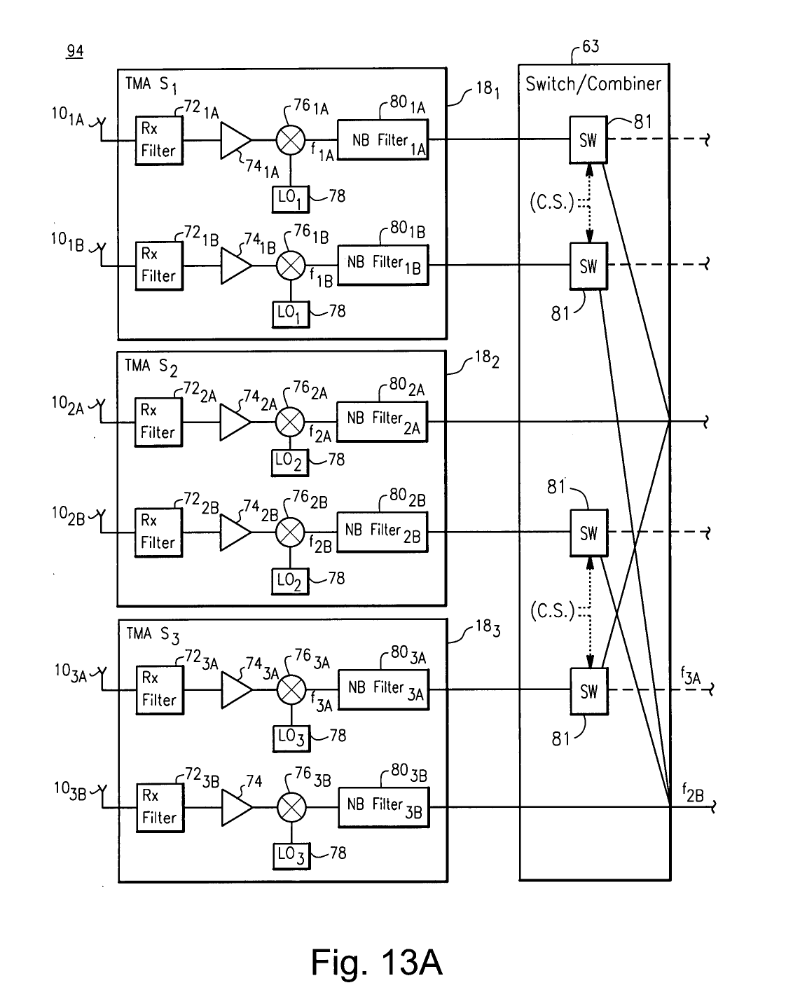

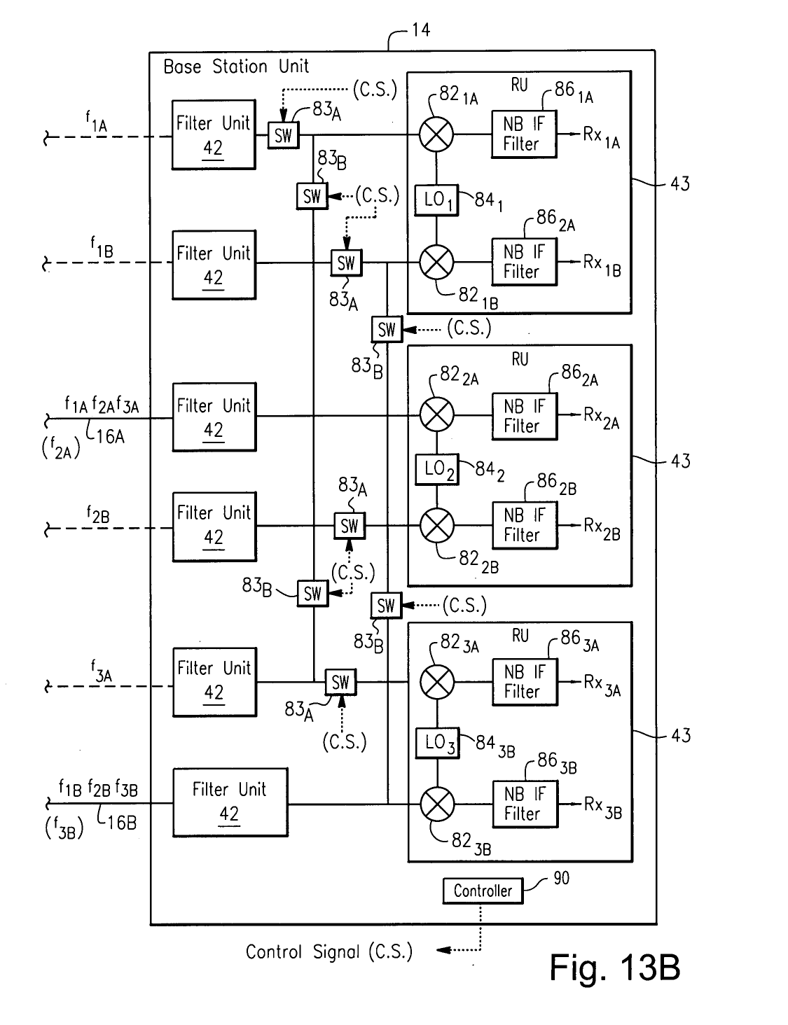

FIGS. 13A and 13B are together a function block diagram of another non-limiting example embodiment of a reconfigurable base station 92 that has multiple sectors and each sector includes diversity reception. Each sector TMA 18₁, 18₂, and 18₃ includes two diversity receive branches A and B, although more than two diversity branches may be used if desired. Each TMA 18₁, 18₂, and 18₃ includes a receive (Rx) filter 72_{1A}, 72_{2A}, and 72_{3A} connected to a respective first antenna 10_{1A}, 10_{2A}, and 10_{3A} as well as a receive (Rx) filter 72_{1B}, 72_{2B}, and 72_{3B} connected to a respective second antenna 10_{1B}, 10_{2B}, and 10_{3B}.

Each receive filter in the first diversity branch is connected to a respective amplifier 74_{1A}, 74_{2A}, and 74_{3A}, and each receive filter in the second diversity branch is connected to a respective amplifier 74_{1B}, 74_{2B}, and 74_{3B}. The amplified output for each of the first branches is connected to a corresponding first mixer 76_{1A}, 76_{2A}, and 76_{3A}, generated for example by a respective sector local oscillator 78₁, 78₂, and 78₃. The amplified output for each of the second branches is connected to a corresponding second mixer 76_{1B}, 76_{2B}, and 76_{3B}, where it is mixed with a frequency translating signal generated for example by the same respective sector local oscillator 78₁, 78₂, and 78₃. The frequency translating signal in this non-limiting example is different for each sector so that the two diversity signals for each sector are converted to a frequency that is different form the other sector signals. Each mixer's output in the first diversity branch is filtered using a respective narrowband (NB) or bandpass filter 80₁A, 80_{2A}, and 80_{3A} centered on the respective frequency to remove other mixer products as well as noise and interference in the available band. Similarly, each mixer's output in the second diversity branch is filtered using a respective narrowband (NB) or bandpass filter 80_{1B}, 80_{2B}, and 80_{3B} centered on the respective frequency to remove other mixer products. The two narrowband filters in each sector are centered on the same respective frequency.

The switch/combiner 63 receives the diversity output signals from each sector antenna unit 18₁, 18₂, and 18₃. A control signal from the controller 90 controls the position of the four switches (SW) 81 in order to configure the base station either as a multi-sector omni-base station or as a multi-sector base station. In a first switch position corresponding to a multi-sector omni-base station configuration, the switches 81 couple the filter outputs of the A diversity branches from each sector to the single feeder 16A so that they are combined to form a first composite signal, and the filter outputs of the B diversity branches from each sector to the single feeder 16B so that they are combined to form a second composite signal. In this way, only one feeder 16A is needed to couple the TMA received signals from the first diversity branches at different frequencies f_{1A}, f_{2A}, and f_{3A} to a base station unit 14, and only one feeder 16B is needed to couple the TMA received signals from the second diversity branches at different frequencies f_{1B}, f_{2B}, and f_{3B} to the base station unit 14.

The base station unit 14 includes six duplex filter units 42. Each filter unit (FU) includes for example a duplex filter and a low noise amplifier. Only two filter units are used in the multi-sector omni-base station configuration, and preferably the other four filter units are powered-down to save power in this configuration. The filter unit 42 coupled to the feeder 16A is connected to mixers 82_{1A}, 82_{2A}, and 82_{3A} in each of the radio units (RUs) 43 via switches 83_{B} (closed by controller 90), and the filter unit 42 coupled to the feeder 16B is connected to mixers 82_{1B}, 82_{2B}, and 82_{3B} in each of the radio units (RUs) 43 via switches 83_{B} (closed by controller 90). (Switches 83_{A} are opened by controller 90). The output from the single local oscillator LO₁ 84₁ is mixed with the inputs to mixers 82_{1A} and 82_{1B} to convert those signals to an IF or other desired frequency (e.g., baseband as in a homodyne) for respective filtering at 86_{1A} and 86_{1B} to produce diversity received signals Rx_{1A} and Rx_{1B} from sector 1. The output from the single local oscillator LO₂ 84₂ is mixed with the inputs to mixers 82_{2A} and 82_{2B} to convert those signals to an IF or other desired frequency for respective filtering at 86_{2A} and 86_{2B} to produce diversity received signals Rx_{2A} and Rx_{2B} from sector 2. The output from the single local oscillator LO₃ 84₃ is mixed with the inputs to mixers 82_{3A} and 82_{3B} to convert those signals to an IF or other desired frequency (e.g., baseband as in a homodyne) for respective filtering at 86_{3A} and 86_{3B} to produce diversity received signals Rx_{3A} and Rx_{3B} from sector 3.

When the controller 90 sets the switches 81 in a second switch position corresponding to the higher capacity, multi-sector base station configuration, the switches 81 couple the filter outputs to their respective one of six feeders 16. The signal on each feeder is provided to its own filter unit 42, (with switches 83_{A} being closed-and switches 83_{B} being opened by the controller 90), and is then processed in its respective receiving unit 43 to produce diversity received signals from each sector: Rx_{1A} and Rx_{1B}, Rx_{2A} and Rx_{2B}, Rx_{3A} and Rx_{3B}.

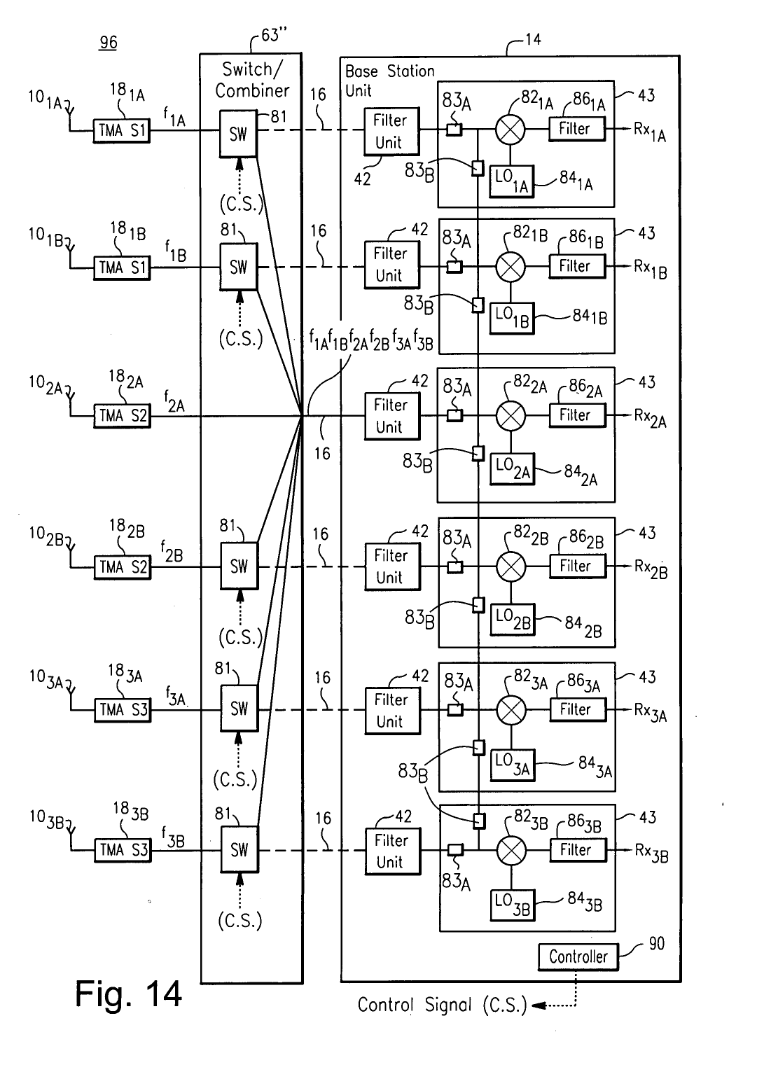

FIG. 14 is a function block diagram of yet another non-limiting example embodiment of a reconfigurable base station with reception diversity that can be converted between a multi-sector, omni-base station configuration and a multi-sector base station configuration 96. In this non-limiting example, there are three sectors S1-S3, and each sector includes two diversity antennas 10_{A} and 10_{B}. Each diversity antenna has its own TMA (a respective one of 18_{1A}-18_{3B}) that generates in this example an output signal at a different frequency (a respective one of f_{1A}-f_{3B}). A control signal from the controller 90 controls the position of the switches (SW) 81, 83_{A}, and 83_{B} in order to configure the base station either as a multi-sector omni-base station or as a multi-sector base station. In a first switch position corresponding to a multi-sector omni-base station configuration, the switches 81 couple the six different frequency carriers f_{1A}-f_{3B} into a single composite signal that is then transported to the base station unit 14 over a single feeder 16. Because each sector diversity signal is at a different frequency in this non-limiting example, they do not directly interfere in the combiner 63 or the feeder 16. The controller 90 closes the switches 83_{B} and opens the switches 83_{A} so that all the mixers 82 are connected to the filter unit 42 coupled to the f_{2A} feeder.

As compared to the example embodiment in FIGS. 13A and 13B, one less combiner and one less feeder are used when the base station is configured as a multi-sector, omni-base station, which saves on expense. A disadvantage is that, depending on the size of the available frequency band allocated to the base station, there may be little or no guard band between each of the six TMA signals f_{1A}-f_{3B}. As a result, there may be added interference, and thus, reduced signal-to-noise ratio. In addition, only a single duplex receive filter 30 and LNA 34 are needed in the base station unit 14, as compared to two in the example embodiment in FIG. 13. On the other hand, six (as compared to three) different local oscillators 84_{1A}-84_{3B} are needed to provide six different local oscillator signals LO_{1A}-LO_{3B} to respective mixers 82_{1A}-82_{3B}.

When the controller 90 sets the switches 81, 83_{A}, and 83_{AB} in a second switch position corresponding to a higher capacity multi-sector base station configuration, the switches 81 couple the filter outputs to their respective one of six feeders 16. The signal on each feeder is provided to its own filter unit 42, and with switches 83_{A} being closed and switches 83_{B} opened, each feeder signal is then processed in its respective receiving unit 43 to produce the to produce diversity received signals from each sector: Rx_{1A} and Rx_{1B}, Rx_{2A} and Rx_{2B}, Rx_{3A} and Rx_{3B}.

As explained in the background, a problem in multi-sector base stations that employ diversity reception is that the diversity antenna outputs for a particular sector are all usually processed in the same TMA. That arrangement is fine unless one of the TMA units becomes faulty or disabled. In that case, the communication in that sector may be completely lost or severely compromised. In the example in FIG. 13, the two diversity branch signals 1A and 1B from sector 1 are processed in the same antenna unit 18₁. If that antenna unit malfunctions, the entire sector may not be processed. The inventors discovered a way to improve the reliability of communication in multi-sector base stations which employ antenna diversity that does not require a redundant backup system.

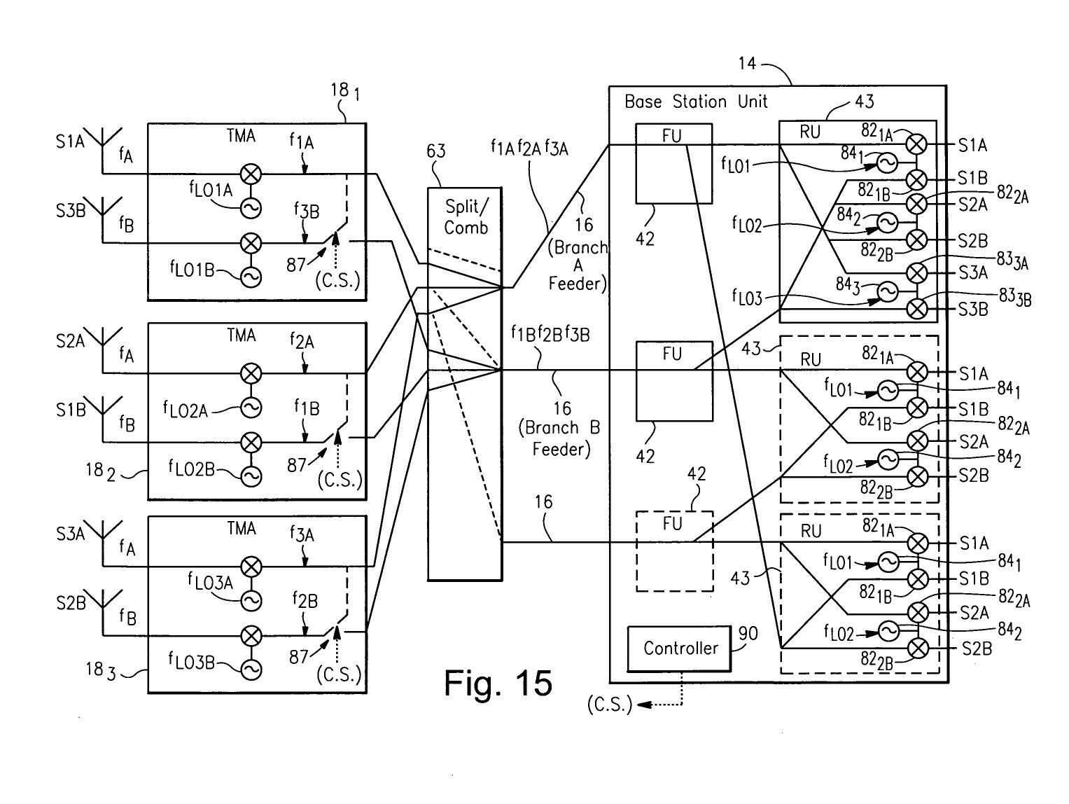

FIG. 15 is a function block diagram of another non-limiting example embodiment of a reconfigurable base station with diversity reception that can be converted between a multi-sector, omni-base station configuration and a multi-sector base station configuration and which has improved reliability and fault tolerance. The base station in this example includes three sectors with an A diversity branch antenna and a B diversity branch antenna for each sector. Each of the antenna units 18₁, 18₂, and 18₃ receives diversity branch signals from different sector antennas. In this example, the first antenna unit 18₁ receives diversity signals from sector 1A (S1A) and sector 3B (S3B) rather than diversity signals 1A and 1B from the same sector 1. The second antenna unit 18₂ receives diversity signals from sector 2A (S2A) and sector 1B (S1B). The third antenna unit 18₃ receives diversity signals from sector 3A (S3A) and sector 2B (S2B). This way if antenna unit 18₁ malfunctions in some way so that the diversity branch signal S1A is lost, the other diversity branch S1B is not also lost. Instead, the other diversity branch S1B is processed in another antenna unit 18₂, which means that signals from sector 1 are still received, but perhaps at a somewhat reduced signal quality depending on the radio conditions.

In the example of FIG. 15, switches 87 are included in the antenna units. The non-dashed lines represent the signal paths for operation in the multi-sector omni-base station configuration. In that configuration, the switches 87 couple the diversity branch signals in each antenna unit 18 together. In an uncombined mode, for example, diversity branch signals S1A and S3B shifted to respective frequencies f_{1A} and f_{3B} are individually provided to the combiner 63. The combiner 63 combines all the sector signals on branch A to three different frequencies f_{1A}-f_{3A} onto one feeder 16 and provides that composite signal to the top filter unit 42 in the base station 14. The combiner 63 combines all the sector signals on the diversity B branches to three different frequencies f_{1B}, f_{2B}, and f_{3B} onto one feeder branch B feeder 16 and provides that composite signal to the middle filter unit 42 in the base station 14. That filter unit 42 provides the filtered composite signal to the top receiving unit 43 for frequency downconverting to restore the original sector signals. Three local oscillators 84₁, 84₂, and 84₃ are included the receiving unit 43. The composite signal is split in the RU 43 and provided so that the same local oscillator may be used to extract all the diversity branch signals from the same sector. The first local oscillator 84₁ is used along with mixers 82_{1A} and 82_{1B} to extract the A and B diversity branch signals for the first sector from the composite signal, a split portion of which is provided to all of the mixers. The second local oscillator 84₂ is used along with mixers 82_{2A} and 82_{2B} to extract the A and B diversity branch signals for the second sector. The third local oscillator 84₃ is used along with mixers 82_{3A} and 82_{3B} to extract the A and B diversity branch signals for the third sector.

In this multi-sector omni-base station configuration, the third filter unit and the second and third radio units (including transmitter power amplifiers) are de-activated to save power. When the switches are set by control signals from the controller 90 to the multi-sector base station configuration, the top two feeders 16 are used. The sector signals S1A, S2A, and S3A are combined onto the top feeder, and the sector signals S1B, S2B, and S3B are combined onto the middle feeder. Switches 83_{A} and 83_{B} are not used because the signal is split in each radio unit 43. When the switches 81 in the combiner 63 are set for the multi-sector base station configuration (indicated with dashed lines in the splitter/combiner 63), the three feeders 16 are used with the first feeder 16 carrying frequencies f_{1A} and f_{3B}, the second feeder 16 carrying frequencies f_{2A} and f_{1B}, and the third feeder 16 carrying frequencies f_{3A} and f_{2B}.

A significant advantage of this arrangement is that if one of the TMA units 18 becomes faulty or disabled, the communication in that sector is not lost or necessarily even compromised. In the example in FIG. 15, the two diversity branch signals 1A and 1B from sector 1 are processed in the different antenna units 18₁ and 18₂. If that either antenna unit malfunctions, the other antenna permits processing of one of the diversity branch signals for sector 1. This improved reliability is achieved without requiring the cost and complexity of a redundant backup system. Another advantage is that one local oscillator 84 can serve two branches because the signals of the branches are situated on different feeders which makes it possible to use the same frequency on the feeder for those two branches.

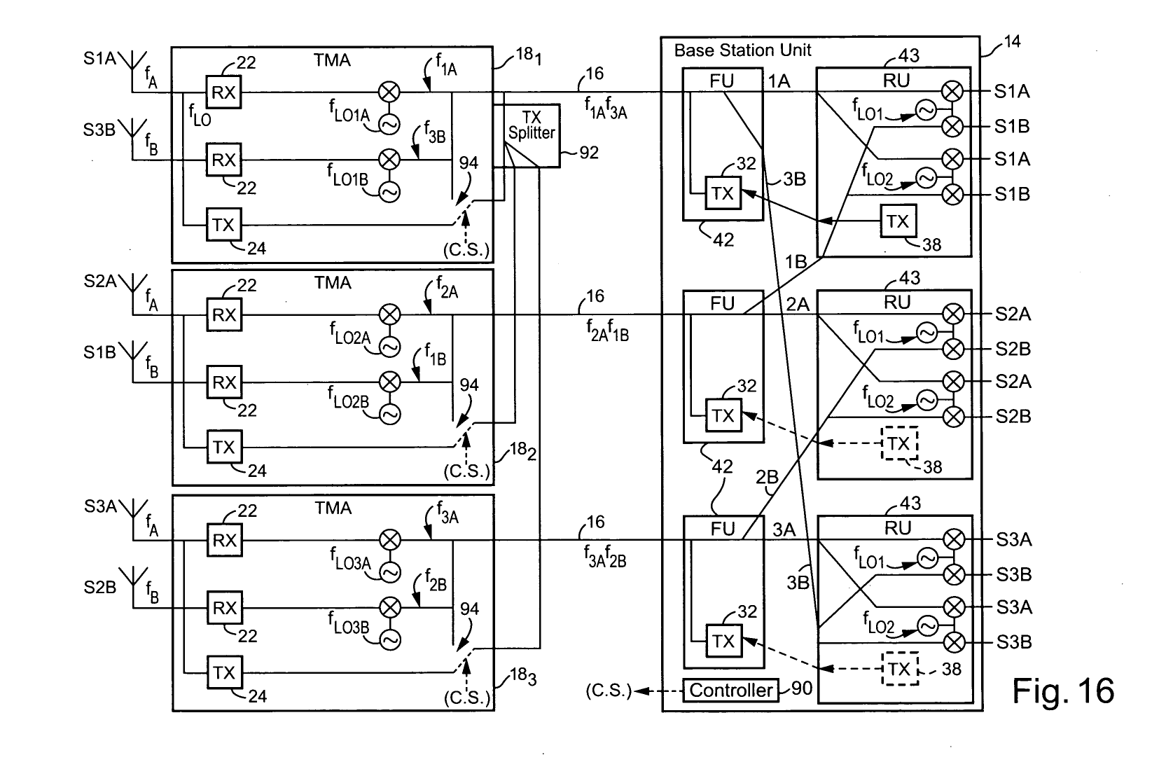

FIG. 16 is a function block diagram of yet another non-limiting example embodiment of a reconfigurable multi-sector base station that permits selective power-down of the transmitter circuitry in the base station. Because the most power-consuming circuitry is in the transmitter side of the base station, the inventors devised a scheme for selectively powering down the transmitter side for a desired time interval without having to power down the receiver side. That way signals can still be received, but considerable power can be saved. Several switches 94 may be provided under the control of the controller 90. Those switches may be positioned in any suitable location where the transmitter filter (TX) 24 is separated from the receiver filter (RX) 22, and in the example, they are located in each TMA 18.

A transmission (TX) splitter 92 may be used in a power savings mode to provide a transmission signal from one (here the top) feeder to each TMA so that multiple sector transmission can still be accomplished. If the respective switch 94 in each TMA is set to the first position shown by the dotted line, then the transmission signal from the TX splitter 92 is connected to the TX duplex filter 24 for transmission in each of the three sectors. In this configuration, only one (or possibly two) transmitters 38 are powered-up to save power, but the transmission is till performed in all three sectors. Two (or more) of the transmitters 38 are powered-down to save power. If the switch 94 is set to the other vertical position in each TMA, the TX splitter 92 is turned off, and each transmission signal from each base station transmitter 38 is sent via its respective feeder 16. In this other vertical switch position, the base station is configured to operate in a higher power mode using all three transmitters 38, i.e., all three power amplifiers are active. Although FIG. 16 is illustrated as a two-way diversity arrangement similar to that shown in FIG. 15, other diversity arrangements may be used, or no diversity need be used.

A reconfigurable base station, such as (but not limited to) those examples described above, allows network operators to provide sufficient capacity to satisfy high demands during time periods of peak traffic volume but at the same time reduce capacity and unnecessary operational expense when the traffic volume is low. That reconfigurable capacity can be added or removed without delay or cost. Base station reconfiguration labor costs, like climbing the base station antenna tower to reconfigure TMAs, are avoided. The needed capacity can be provided in an inexpensive, energy efficient way that flexibly permits fast and automated base station reconfiguration. In addition, the base station reliability is enhanced without having to add a redundant system by processing diversity branch signals from the same sector in different antenna units.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. Radio base station apparatus, comprising:
multiple sector antenna units, each of the multiple sector antenna units having an antenna for receiving a carrier signal associated with an antenna frequency in an available frequency band, and
electronic circuitry configured to convert a radio base station between a multiple sector base station configuration, where each sector antenna unit is connected to an associated filtering unit and an associated radio unit in a base station unit, and a multi-sector omni-base station configuration, where at least two of the sector antenna units share a common filtering unit connected to a common radio unit in the base station unit.

2. The apparatus in claim 1, further comprising:
a frequency converter for frequency converting the carrier signal received by one of the multiple antenna units from the antenna frequency to a respective frequency different from the antenna frequency, where at least two of the carrier signals associated with the multiple antenna units and combined in the combiner are at a different frequency,
wherein for the multi-sector omni-base station configuration, the electronic circuitry is configured to combine different frequency carrier signals associated with each of the multiple antenna units into a composite signal and provide the composite signal onto a feeder connected to a base station unit, and
wherein for the multi-sector base station configuration, the electronic circuitry is configured to provide a signal associated with each of the multiple antenna units onto a respective one of multiple feeders connected to the base station unit.

3. The apparatus in claim 2, wherein for the multi-sector omni-base station configuration, each radio unit includes a frequency downconverter for extracting from the composite signal a respective one of the carrier signals corresponding to the multiple sector antenna units, each frequency downconverter including one or more base station mixers configured to frequency convert a corresponding one of the respective carrier signals associated with a different frequency to an intermediate frequency or to baseband for further processing.

4. The apparatus in claim 2, wherein for the multi-sector omni-base station configuration, the number of multiple sector antenna units having a corresponding frequency converter is less than the number of multiple sector antenna units.

5. The apparatus in claim 2, wherein for the multi-sector omni-base station configuration, the number of multiple sector antenna units having a corresponding frequency converter is the same as the number of multiple sector antenna units.

6. The apparatus in claim 2, wherein for the multi-sector omni-base station configuration, the electronic circuitry is configured to combine carrier signals associated with each of the multiple antenna units to create a composite signal in which all of the carrier signals combined are associated with a different frequency.

7. The apparatus in claim 2, wherein for the multi-sector omni-base station configuration, the electronic circuitry is configured to combine carrier signals associated with each of the multiple antenna units to create a composite signal in which some of the carrier signals to be combined are at a different frequency.

8. The apparatus in claim 2, wherein in the multi-sector omni-base station configuration, the electronic circuitry includes switching circuitry controllable to connect one or more of the sector signals to the feeder so that multiple sector signals are connected to the base station via the feeder.

9. The apparatus in claim 1, wherein for the multi-sector omni-base station configuration, if there are multiple respective different frequency bands, then those respective different frequencies are distributed over the available frequency band.

10. The apparatus in claim 1, wherein each antenna unit is a tower mounted amplifier (TMA) unit including a receiver filter corresponding to the available bandwidth connected to an amplifier for amplifying the received signal.

11. The apparatus in claim 1, further comprising multiple feeders and multiple radio units, wherein for the multi-sector base station configuration, the electronic circuitry is configured to route a signal from each of the multiple sector antenna units over a respective one of the feeders connected to a respective radio unit.

12. The apparatus in claim 11, wherein the electronic circuitry is configured to power-down one or more of the respective filtering units and/or radio unit including a power amplifier when the base station is configured in a multi-sector omni-base station configuration.

13. The apparatus in claim 1, wherein each sector antenna unit is connected to a first diversity antenna and a second diversity antenna, and wherein for the multi-sector omni-base station configuration, the electronic circuitry is configured to combine signals associated with each sector's first diversity antenna to create a first composite signal and provide the first composite signal onto a first feeder connected to the base station unit, to combine signals associated with each sector's second diversity antennas to create a second composite signal, and to provide the second composite signal onto a second feeder connected to the base station unit.

14. Radio base station apparatus, comprising:
multiple sector antenna units coupled to a base station unit, each of the multiple sector antenna units having an antenna for receiving a carrier signal associated with an antenna frequency in an available frequency band, and
wherein each sector antenna unit is connected to a first diversity antenna signal from one sector and a second diversity antenna signal from a different sector.

15. The apparatus in claim 14, further comprising: electronic circuitry configured to convert a radio base station between a multiple sector base station configuration, where each sector antenna unit is connected to an associated filtering unit and an associated radio unit in the base station unit, and a multi-sector omni-base station configuration, where at least two of the sector antenna units share a common filtering unit connected to a common radio unit in the base station unit.

16. The apparatus in claim 15, wherein for the multi-sector omni-base station configuration, the electronic circuitry is configured to combine signals from the sector antenna units at different frequencies to create a composite signal and provide the composite signal onto a feeder connected to the common filtering unit and receiver, and wherein the common receiver includes frequency conversion circuitry for extracting individual ones of the sector diversity signals.

17. The apparatus in claim 16, wherein the base station unit includes a local oscillator associated with each sector, and wherein for the multi-sector omni-base station configuration, the electronic circuitry is configured to use a same one of the local oscillators to extract from the composite signal diversity signals from the same sector.

18. Radio base station apparatus, comprising:
multiple sector antenna units, each of the multiple sector antenna units having an antenna for receiving a carrier signal associated with an antenna frequency in an available frequency band;
multiple base station transceivers, each transceiver having transmission circuitry and receiving circuitry, and each sector antenna unit being connectable to one of the multiple base station transceivers; and
electronic circuitry configured to selectively power down at least a part of the transmission circuitry for a desired time interval without having to power down at least a part of the receiving circuitry.

19. The apparatus in claim 18, further comprising a transmission splitter, wherein each sector antenna unit includes a receiving filter and a transmission filter, and wherein the electronic circuitry is configured to selectively switch between a first power saving mode, where the transmission splitter is activated and a transmission signal from one transmitter is provided to the transmission filter in two or more sector antenna units, and a second higher power mode, where the transmission splitter is deactivated and a transmission signal from two or more transmitters is provided to a respective transmission filter in two or more sector antenna units.

20. The apparatus in claim 18, further comprising switches controllable by the electronic circuitry to switch in or out the transmission circuitry.

21. The apparatus in claim 18, wherein each sector antenna unit includes diversity antennas, and wherein each sector antenna unit is connected to a first diversity antenna signal from one sector and a second diversity antenna signal from a different sector.

22. A method for use in a radio base station, comprising:
receiving a carrier signal associated with an antenna frequency in an available frequency band at each of the multiple sector antenna units, each sector antenna unit being connected to an antenna, and
in response to a control signal, automatically converting the radio base station between a multiple sector base station configuration, where each sector antenna unit is connected to an associated filtering unit and an associated radio unit in a base station unit, and a multi-sector omni-base station configuration, where at least two of the sector antenna units share a common filtering unit connected to a common radio unit in the base station unit.

23. The method in claim 22, further comprising:
frequency converting the carrier signal received by one of the multiple antenna units from the antenna frequency to a respective frequency different from the antenna frequency, where at least two of the carrier signals associated with the multiple antenna units and combined in the combiner are at a different frequency,
wherein for the multi-sector omni-base station configuration, the method further comprises:
combining different frequency carrier signals associated with each of the multiple antenna units into a composite signal, and
providing the composite signal onto a feeder connected to a base station unit, and
wherein for the multi-sector base station configuration, the method further comprises providing a signal associated with each of the multiple units onto a respective one of multiple feeders connected to the base station unit.

24. The method in claim 23, wherein for the multi-sector omni-base station configuration, each receiving unit extracting from the composite signal a respective one of the carrier signals corresponding to the multiple sector antenna units using a frequency downconverter to frequency convert a corresponding one of the respective carrier signals associated with a different frequency to an intermediate frequency or to baseband for further processing.

25. The method in claim 23, wherein for the multi-sector omni-base station configuration, the number of multiple sector antenna units having a corresponding frequency converter is less than the number of multiple sector antenna units.

26. The method in claim 23, wherein for the multi-sector omni-base station configuration, the number of multiple sector antenna units having a corresponding frequency converter is the same as the number of multiple sector antenna units.

27. The method in claim 23, wherein for the multi-sector omni-base station configuration, the method further comprises combining carrier signals associated with each of the multiple antenna units to create a composite signal in which all of the carrier signals combined are associated with a different frequency.

28. The method in claim 23, wherein for the multi-sector omni-base station configuration, the further comprises combining carrier signals associated with each of the multiple antenna units to create a composite signal in which some of the carrier signals to be combined are at a different frequency.

29. The method in claim 23, wherein in the multi-sector omni-base station configuration, the method further comprises switchably connecting one or more of the sector signals to the feeder so that multiple sector signals are connected to the base station via the feeder.

30. The method in claim 22, wherein the base station includes multiple feeders and multiple radio units, and wherein for the multi-sector omni-base station configuration, the method further comprises powering-down one or more of the filtering units and/or radio units.

31. The method in claim 22, wherein the base station includes multiple feeders and multiple radio units, and wherein for the multi-sector base station configuration, the method further comprises routing a signal from each of the multiple sector antenna unit over a respective one of the feeders connected to a respective radio unit that includes a power amplifier.

32. The method in claim 22, further comprising powering-down one or more of the respective receiving units when the base station is configured in a multi-sector omni-base station configuration.

33. The method in claim 22, wherein each sector antenna unit is connected to a first diversity antenna and a second diversity antenna, and wherein for the multi-sector omni-base station configuration, the method further comprises
combining signals associated with each sector's first diversity antenna to create a first composite signal and provide the first composite signal onto a first feeder connected to the base station unit,
combining signals associated with each sector's second diversity antennas to create a second composite signal, and
providing the second composite signal onto a second feeder connected to the base station unit.

34. A method for use in a radio base station, comprising:
receiving a carrier signal associated with an antenna frequency in an available frequency band at each one of multiple sector antenna units, each sector antenna unit being connected to an antenna and to a base station unit,
wherein each sector antenna unit is connected to a first diversity antenna signal from one sector and a second diversity antenna signal from a different sector.

35. The method in claim 34, further comprising:
in response to a control signal, automatically converting the radio base station between a multiple sector base station configuration, where each sector antenna unit is connected to an associated filtering unit and an associated radio unit in a base station unit, and a multi-sector omni-base station configuration, where at least two of the sector antenna units share a common filtering unit connected to a common radio unit in the base station unit,
wherein for the multi-sector omni-base station configuration, the method further comprises:
combining signals from the sector antenna units at different frequencies to create a composite signal,
providing the composite signal onto a feeder connected to the common filtering unit and receiver, and
extracting individual ones of the sector diversity signals at the receiver.

36. The method in claim 35, wherein the base station unit includes a local oscillator associated with each sector, and wherein for the multi-sector omni-base station configuration, the method further comprises using a same one of the local oscillators to extract from the composite signal diversity signals from the same sector.

37. A method for use in a radio base station including multiple sector antenna units, each of the multiple sector antenna units having an antenna for receiving a carrier signal associated with an antenna frequency in an available frequency band, and multiple base station transceivers, each transceiver having transmission circuitry and receiving circuitry, and each sector antenna unit being connectable to one of the multiple base station transceivers, the method comprising:
selectively powering down the transmission circuitry for a desired time interval without having to power down the receiving circuitry.

38. The method in claim 37, wherein the radio base station includes a transmission splitter and each sector antenna unit includes a receiving filter and a transmission filter, the method further comprising:
selectively switching between a first power saving mode, where the transmission splitter is activated and a transmission signal from one transmitter is provided to the transmission filter in two or more sector antenna units, and a second higher power mode, where the transmission splitter is deactivated and a transmission signal from two or more transmitters is provided to a respective transmission filter in two or more sector antenna units.

39. The method in claim 37, wherein each sector antenna unit includes diversity antennas, the method further comprising:
connecting each sector antenna unit to a first diversity antenna signal from one sector and to a second diversity antenna signal from a different sector.
